(19) United States
(12) Patent Application Publication
(10) Pub. No.: US 2026/0227093 A1
(43) Pub. Date: Aug. 6, 2026

(54) ELECTRIC HEATER FOR VEHICLE

(71) Applicant: I.R.C.A. S.P.A INDUSTRIA RESISTENZE CORAZZATE E AFFINI, Vittorio Veneto (IT)

(72) Inventors: Michele BENVENUTO, Treviso (IT); Roberta COLLOT, Conegilano (IT); Andrea DEI TOS, Vittorio Veneto (IT); Federico ZOPPAS, Treviso (IT)

(21) Appl. No.: 19/149,546

(22) PCT Filed: Jan. 24, 2024
(86) PCT No.: PCT/IB2024/050671

§ 371 Date: Jul. 20, 2025

(30) Foreign Application Priority Data
Jan. 24, 2023 (IT) 102023000000984

(51) Int. Cl. F24H 1/12; B60H 1/22; H05B 3/40

(52) U.S. Cl. CPC F24H 1/121; B60H 1/2221; H05B 3/40

(57) ABSTRACT

An electric heater (1) for a vehicle, adapted to heat a liquid crossing said heater, comprising
a body (2) made of die-cast metal material;
at least one electrical resistor (3) at least partially incorporated along a first median plane (X) of said body (2); side of the heater;
a first flow path (4) for the liquid, from the inlet section (10) to the outlet section (11), made on a first face of said body (2) arranged at a first side of said first median plane (X);
a second flow path (5) for the liquid, from said inlet section (10) to said outlet section (11), made on a second face of said body (2) arranged at a second side of said first median plane (X) opposite the first side;
wherein the first flow path (4) and the second flow path (5) are arranged symmetrically both with respect to said first median plane (X) and to a second median plane (Y) of the body (2) perpendicular to said first median plane (X).

### FIELD OF THE INVENTION

The present invention relates to an electric heater for vehicles, preferably but not necessarily electric or hybrid vehicles, in particular to heat a battery cooling liquid, in case of low outdoor temperatures, keeping the ideal operating temperature constant, or to heat a liquid for use in an exchanger for heating the air in the passenger compartment.

### BACKGROUND ART

The battery is essential for the operation of an electric or hybrid vehicle. It must provide the amount of energy necessary to drive the vehicle quickly and reliably. Most batteries are high-voltage hybrid lithium-ion and nickel-metal batteries.

It is essential that the batteries used are operated within a determined temperature range. In fact, the service life starts reducing from an operating temperature of +40° C., while performance and power decrease below −10° C. Further, the temperature difference between the individual battery cells must not exceed a certain value. Exceeding the limit temperatures results in more rapid aging and therefore the corresponding early failure of the battery. Vehicle manufacturers aim for a battery life equal to that of the vehicle. Therefore, the aging process can only be counteracted by optimally managing the temperature.

The battery unit generally includes battery cells, a cooling plate and an auxiliary electric heater. The cooling plate, mounted in the battery cell block, is crossed by the coolant composed, for example, of water and glycol.

To ensure higher performance and maximum service life of the battery, the temperature of the relative coolant must be comprised between approximately 15 and 30° C. When temperatures are too high, the liquid is cooled, for example, by a low-temperature radiator. If, on the contrary, the temperatures are too low, the coolant is heated by the auxiliary electric heater. The latter thus guarantees sufficient control of the battery temperature at low outdoor temperatures.

To carry out this heating, the battery is integrated into a secondary circuit. This circuit guarantees constant maintenance of the ideal operating temperature, between 15° and 30° C.

Such an electric heater generally comprises at least one electric heating unit for generating heat and for discharging the generated heat to a heat transport medium, represented by the aforementioned liquid, by means of a body made of metal material with which the electric heating unit is in contact.

Such liquid can be, for example, water, glycol, water and glycol, or another suitable heat-transporting liquid.

This liquid flows along a flow path comprising at least one channel arranged on one face of said metal body and closed by a cover fastened onto said metal body. Said at least one channel communicates directly at its ends with the inlet section and the outlet section of the heater.

The electric heater must be compact and is generally shaped as a rectangular parallelepiped. The diameter of the inlet and outlet ports or pipe connections is defined by the section of the hydraulic circuit pipes.

The electric heating unit includes a heating element, for example a tubular resistor immersed in the thickness of the metal body or a film resistance deposited on a surface of said metal body which is not in contact with the liquid.

The electric heating unit is connected to an electronic control unit that allows the thermal power of the heating unit to be controlled.

The electronic control unit can, for example, comprise at least one electronic switch, such as a power transistor or other semiconductor power device, for example for controlling an electric current in the heating unit or for controlling a voltage applied to the heating unit.

The power transistor can for example be an insulated gate bipolar transistor (IGBT). The power transistor can be electrically connected in series with the heating element. As a side effect, the electronic control unit typically generates heat that must be dissipated to prevent the control unit from overheating.

Vehicle manufacturers would prefer to use the same electric heater in all vehicle platforms, i.e. a heater with various orientation possibilities within the platform.

Disadvantageously, the known solutions have only one face of the metal body used as a heat exchange surface, and with some mounting orientations of the heater air pockets form in some stagnation areas inside the channel. Therefore, there is a limitation to the possible mounting orientation of the heater. In particular, since the power density on the metal body is very high to reduce its dimensions, layers of air and/or vapor can form at the solid/liquid interface, which prevent heat exchange from the solid to the liquid, to the point of triggering film boiling conditions which could lead to catastrophic melting of the metal body.

The orientation of the heat exchange surface can be favorable or unfavorable with respect to the possibility of removing the air and/or vapor from the exchange surface, therefore respectively unfavorable or favorable for the formation of the boiling film. The gas always tends to rise upwards being less dense than the surrounding liquid, but the orientation of the heat exchange surface, which depends on the positioning of the heater inside a specific vehicle platform, can strongly compromise the removal of the air and/or vapor from the exchange surface.

Vehicle manufacturers would prefer to use the same electric heater in all vehicle platforms while also having the freedom to connect the heater inlet and outlet ports arbitrarily.

Further, reliable operation is required by manufacturers under typical vehicle use conditions, which involve variability in the direction of the gravitational force relative to the heater due to longitudinal and transverse slopes of the road path, as well as inertial forces caused by braking or direction change accelerations.

Disadvantageously, in the known solutions, the input port and the outlet port of the heater are predefined since the power transistors are positioned at the inlet section of the heater, which is unheated and arranged upstream of the effective heating area, so as to dissipate the heat generated by the electronic control unit by means of the liquid entering from the inlet port. Therefore, if the manufacturer mounted the heater in such a way as to reverse the direction of the flow of liquid between inlet and outlet, the electronic switches would no longer be adequately cooled because they would be located at the outlet section where the liquid is too hot.

In addition to these drawbacks, other needs of manufacturers are those of:
reducing pressure losses in the flow of liquid passing through the electric heater, as vehicle centrifugal pumps have low head;
preventing the formation of recirculation zones in the heating zone of the channel or channels, which would lead to local overheating;
containing the temperature of the walls of the channel or channels of the metal body to prevent degradation of the cooling liquid;
reducing the weight and dimensions of the electric heater.

The aforesaid requirements are however conflicting because:
to reduce pressure losses and recirculation zones, large uniform passage sections are needed, to the detriment of dimensions, and without discontinuities;
to reduce the temperature of the walls of the channel or channels it is necessary to increase the heat exchange surface, to the detriment of the dimensions, or to introduce discontinuities in the flow, for example variations in section, turbulators, sharp curves, to the detriment of the pressure losses.

There are, for example, some solutions in which the inlet and outlet sections of the heater are voluminous collectors thermally isolated from the effective heating area, resulting in a considerable size and not contributing to the heating of the liquid and, thus, reducing the heat exchange surface.

Furthermore, these inlet and outlet sections have a much larger cross-section than the inlet/outlet ports, causing strong liquid speed variations which increase pressure losses and involve a risk of overheating in recirculation zones.

Thus, there is a need to provide an innovative electric heater to solve the aforementioned drawbacks.

### SUMMARY OF THE INVENTION

An object of the present invention is to provide an electric heater for vehicles that allows any mounting orientation, preventing the formation of stagnant air pockets within the flow path, therefore not triggering film boiling conditions that could lead to a catastrophic melting of the metal body.

Another object of the present invention is to provide an electric heater that also allows the inlet and outlet ports of the heater to be arbitrarily connected to the corresponding hydraulic circuit without any contraindications.

A further object of the present invention is to provide an electric heater that allows better performance, simultaneously guaranteeing good cooling of the electronic control unit, a greater heat exchange surface, low pressure losses, high thermal power and reduced dimensions.

The present invention achieves at least one of these objects, and other objects which will be evident in light of the present description, by means of an electric heater for a vehicle, adapted to heat a liquid passing through said heater, comprising
a body made of die-cast metal material;
at least one electrical resistor at least partially incorporated along a first median plane X of said body;
an inlet section and an outlet section for the liquid, both arranged on a same side of the heater;
a first flow path for the liquid, from the inlet section to the outlet section, made on a first face of said body arranged at a first side of said first median plane X;
a second flow path for the liquid, from said inlet section to said outlet section, made on a second face of said body arranged at a second side of said first median plane X opposite the first side;
wherein the first flow path and the second flow path, which include said inlet section and said outlet section, are arranged symmetrically both with respect to said first median plane X and with respect to a second median plane Y of the body perpendicular to said first median plane X.

Advantageously, the heater of the invention in any mounting position always has at least one face of the metal exchanger body which presents an orientation of the exchange surface favorable to the possibility of removing the air and/or vapor, even in conditions of road slope and in the presence of lateral accelerations, and which can therefore release heat and prevent catastrophic melting of the exchanger body, should the other surface experience film boiling conditions.

A further advantage of the invention is represented by the fact that the liquid circuit inside the heater is symmetrical and the flow direction can be freely reversed, allowing vehicle manufacturers to use the heater of the invention in all vehicle platforms with the freedom to connect the inlet and outlet ports of the heater arbitrarily.

In a preferred embodiment, another advantage of the invention is represented by the fact that the flow direction can be reversed inside the heater without jeopardizing the dispersion of heat of the electronic control unit, which is cooled by a liquid at an intermediate compromise temperature between inlet and outlet.

Further features and advantages of the invention will become more apparent in the light of the detailed description of exemplary but not exclusive embodiments.

The dependent claims describe particular embodiments of the invention.

### BRIEF DESCRIPTION OF THE FIGURES

The description of the invention refers to the accompanying drawings, which are provided by way of non-limiting example, in which:

FIG. 1 shows a perspective view of an electric heater according to the invention;

FIG. 2 shows a cross-section of the electric heater in FIG. 1;

FIG. 3 shows a view of a face of the heat exchanger body made of die-cast metal material in a first embodiment of the invention;

FIG. 4 shows a view of a face of the heat exchanger body made of die-cast metal material in a second embodiment of the invention;

FIG. 5 shows a view of a face of the heat exchanger body made of die-cast metal material in a third embodiment of the invention;

FIG. 6 shows a view of the face of the heat exchanger body made of die-cast metal material in a fourth embodiment of the invention;

FIG. 7 shows a sectional view, along a first median plane, of the heater of the invention with a first electrical resistor variant;

FIG. 8 shows a sectional view, along a first median plane, of the heater of the invention with a second electrical resistor variant;

FIG. 9 shows an enlargement of a sectional view of part of a flow path of the heater of the invention;

FIG. 10 shows an enlargement of a further sectional view of the two flow paths of a heater of the invention, such as those illustrated in FIGS. 3-6;

FIG. 11 shows a perspective view of a component of the heater of the invention;

FIG. 12 shows a sectional view of some components of the heater of the invention;

FIG. 13 shows an exemplary view of the position of some components of the heater of the invention;

FIG. 14 shows a first sectional view of some details of the heater of the invention;

FIG. 15 shows a second sectional view of said details of the heater of the invention;

FIG. 16 shows a first variant of a component of the heater;

FIG. 17 shows a second variant of the component in FIG. 16;

FIG. 18 shows a third variant of the component in FIG. 16;

FIG. 19 shows a fourth variant of the component in FIG. 16.

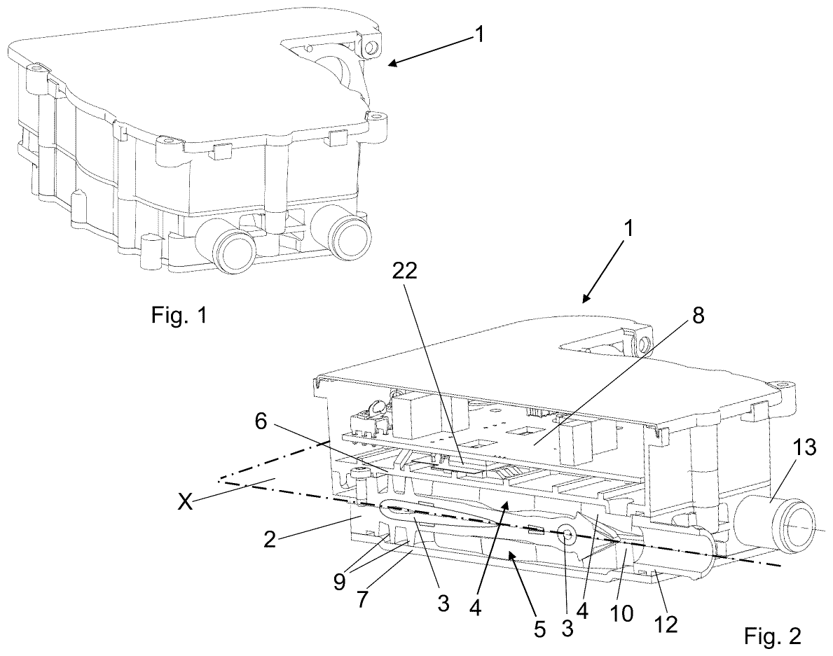

The same reference numerals and letters in the drawings identify the same elements or components.

### DESCRIPTION OF EXAMPLE EMBODIMENTS OF THE INVENTION

With reference to the Figures, some examples of an electric heater for vehicles, in particular electric or hybrid vehicles, are illustrated.

This electric heater can be used, in particular, to heat a battery cooling liquid of an electric or hybrid vehicle, in case of low outdoor temperatures, keeping the ideal operating temperature constant, or to heat a liquid for use in an exchanger for heating the air in the passenger compartment.

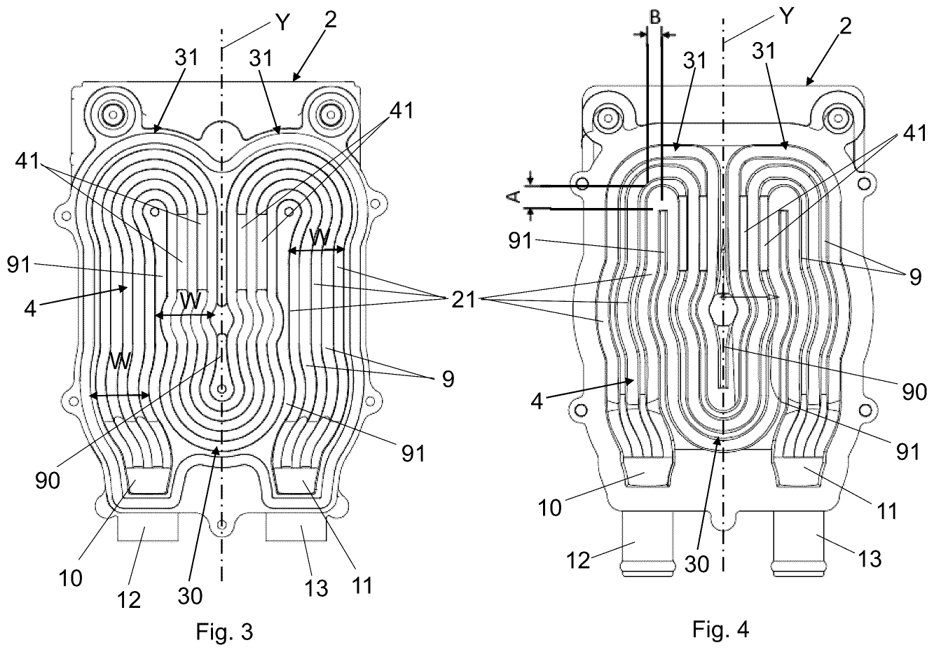

In all the embodiments of the invention, the electric heater comprises
a body 2 made of die-cast metal material, preferably a single body as shown for example in FIGS. 2-10;
at least one electrical resistor 3, 32, 33 at least partially incorporated along a first median plane X of the body 2 (FIGS. 2, 7-8);
an inlet section 10 and an outlet section 11 for the liquid, both arranged on a same side of the heater (FIGS. 3-6).

Preferably, the body 2 is a block of die-cast metal material, e.g. aluminum or another suitable material, having a substantially flat shape with two major dimensions (length and width), preferably at least double the third dimension (thickness).

Advantageously there are provided (FIGS. 2-6 and 10) a first flow path 4 for the liquid, from the inlet section 10 to the outlet section 11, made on a first face of the body 2 arranged at a first side of said first median plane X; and a second flow path 5 for the liquid, from said inlet section 10 to said outlet section 11, made on a second face of the body 2 arranged at a second side of said first median plane X opposite the first side. In other words, as can be seen in FIGS. 2 and 10, the first face of the body 2 is arranged on a first side of said first median plane X whereas the second face of said body 2 is arranged on a second side of said first median plane X opposite the first side. This way, vehicle manufacturers can use the heater of the invention with any orientation within vehicle platforms, as the heater will always have at least one face of the exchanger body that has a heat exchange surface favorable to the possibility of removing the air and/or vapor that can form at the solid/liquid interface. Further, this allows for more reliable operation under typical vehicle use conditions, which involve variability in the direction of the gravitational force relative to the heater due to longitudinal and transverse slopes of the road path, as well as inertial forces caused by braking or direction change accelerations.

Advantageously, the first flow path 4 and the second flow path 5, which include in common both the inlet section 10 and the outlet section 11, are symmetrically arranged both with respect to the first median plane X and with respect to a second median plane Y of the body 2 perpendicular to said first median plane X. In particular, the first flow path 4 and the second flow path 5 are arranged symmetrically to each other with respect to the first median plane X; and each flow path 4, 5 is also symmetrical with respect to the second median plane Y. Therefore, the first median plane X of the body 2 is a plane of symmetry of at least one portion of the body 2 which comprises the first flow path 4 and the second flow path 5. In fact, the median plane X divides said at least one portion of the body 2 into two parts which correspond in a planar symmetry of plane X. This configuration of the liquid circuit inside the heater of the invention allows vehicle manufacturers to use the heater of the invention in all vehicle platforms with the freedom to connect the inlet and outlet ports of the heater arbitrarily, freely reversing the flow direction.

The heater of the invention further comprises (FIG. 2):
a first cover 6 that closes with a first side thereof the first flow path 4;
a second cover 7 which closes with a first side thereof the second flow path 5;
an electronic control unit 8 arranged on a second side of said first cover 6 or second cover 7, opposite the first side, and comprising at least one electronic switch 22.

Preferably, the covers 6, 7 are arranged parallel to each other and to the median plane X.

The covers 6, 7 preferably rest in the compression area of a respective sealing gasket on the outer perimeter, respectively, of the first face and of the second face of the body 2.

The covers 6, 7 are thus components separated from the heating body 2, being connected to the latter, for example, with screws and gaskets.

Preferably, to improve the compactness of the solution of the invention and simultaneously increase the heat exchange between body 2 and liquid, both the first flow path 4 and the second flow path 5 are provided with an odd number of hairpin bends, preferably but not necessarily only three hairpin bends 30, 31 (FIGS. 3-6), and comprise a plurality of channels 21, substantially parallel to one another, which branch off from the inlet section 10 and flow into the outlet section 11, both of said sections arranged on a same side of the heater.

Advantageously, the channels 21 of the first flow path 4 and the second flow path 5 are delimited by bulkheads 9 projecting respectively from the first face and second face of the body 2. Such bulkheads 9, and thus the channels 21, can be made by mechanically processing the first face and the second face of the body 2 or be directly made by die-casting, producing a hollow area on both faces from which the bulkheads project.

The presence of the bulkheads 9 on both faces of the body 2 improves the removal of heat by increasing the effective heat exchange surface, at the same time reducing the wall temperature of the channels without the need to increase the overall dimensions and without the need for discontinuities in the flow and, therefore, higher pressure losses.

Preferably, each channel 21 has a width of about 3-6 mm and a height of about 7-12 mm.

Therefore, the small height of the bulkhead 9 increases the heat exchange efficiency thereof.

By way of non-limiting example, as shown in FIGS. 3-6, each flow path 4, 5, comprises three channels 21 and two intermediate bulkheads 9. FIGS. 3-6 illustrate only the first flow path 4 provided on the first face of the body 2. On the opposite and underlying side, i.e. on the second face of the body 2, the second flow path 5 is provided.

In a preferred configuration, both for the first flow path 4 and for the second flow path 5, the intermediate hairpin bend 30 of said three hairpin bends is arranged at the second median plane Y and proximal to the side of the heater where the inlet section 10 and the outlet section 11 are arranged; while two side hairpin bends 31 of said three hairpin bends are arranged symmetrically with respect to said second median plane Y and distal from said side of the heater where the inlet section 10 and the outlet section 11 are arranged.

Therefore, the first flow path 4 and the second flow path 5, and thus the respective channels 21, have a substantially capital M shape, with the side legs of the M shape at the inlet section 10 and outlet section 11, respectively.

This M shape of each flow path 4, 5 is defined by further bulkheads 90, 91 formed on the two opposite faces of the body 2. In particular, two side bulkheads 91 are arranged symmetrically with respect to the second median plane Y and branch off from the side of the body 2 where the inlet section 10 and outlet section 11 are arranged; whereas a central bulkhead 90 is arranged along said second plane Y and branches off from the side of the body 2 opposite the one where the inlet section 10 and the outlet section 11 are arranged.

Optionally, in the stretches that connect the inlet section 10 to the proximal side hairpin bend 31, the outlet section 11 to the proximal side hairpin bend 31, and the side hairpin bends 31 to the intermediate hairpin bend 30, respectively, the bulkheads 9, 90, 91, and therefore the respective channels 21, have at least one undulated portion for producing minimal turbulence in the liquid.

Preferably, in the heater of the invention, there are provided:
a first port or pipe connection 12, projecting from the body 2 and communicating with the inlet section 10;
and a second port or pipe connection 13, projecting from the body 2 and communicating with the outlet section 11.

The first port 12 and second port 13 can be arranged symmetrically with respect to the second median plane Y.

Advantageously, the ratio between the width W of the first flow path 4 and of the second flow path 5, and the inner diameter of the first port 12 and of the second port 13 is in a range from 1 to 2, preferably from 1.2 to 1.6. This ratio allows the liquid not to undergo strong speed variations at the inlet and outlet of the heater, which would increase pressure losses and imply the risk of overheating in possible recirculation zones.

The width W, indicated for example in FIG. 3, is the width of the flow path which includes the width of the channels 21 of said path and the thickness of the intermediate bulkheads 9 between said channels 21. In the example of the Figures, the width of the flow path consists of the width of the three channels 21 and the thickness of the two intermediate bullheads 9.

A preferred variant of the heater of the invention provides that the at least one electronic switch 22 is arranged in proximity to the second median plane Y, in a distal position both from the inlet section 10 and from the outlet section 11. Even more preferably, this position is a distal and median position, i.e. equally distal, between the inlet section 10 and the outlet section 11. This configuration allows the flow direction of liquid inside the heater to be reversed without jeopardizing the heat dispersion of the electronic control unit 8, which is, in fact, cooled by a liquid at an intermediate compromise temperature between inlet and outlet.

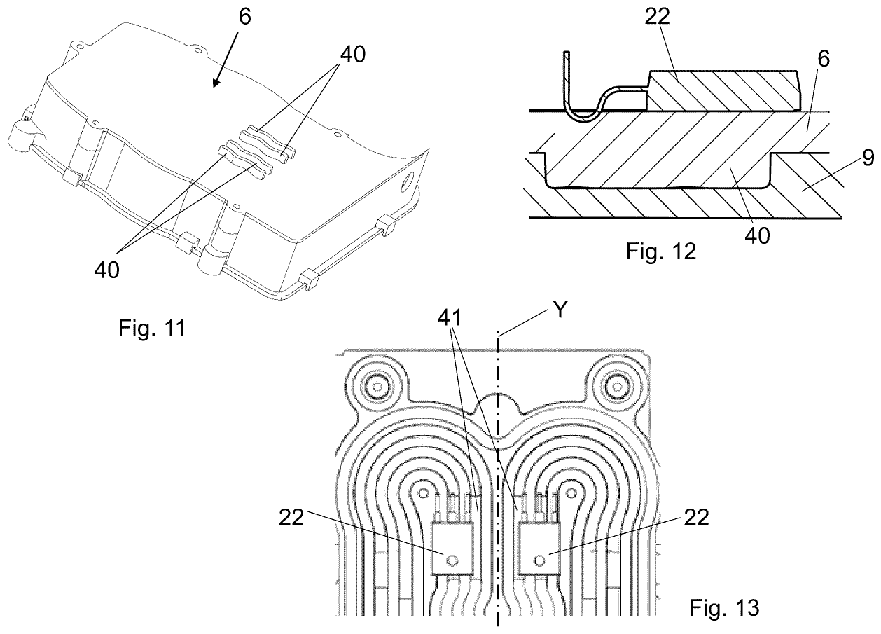

Preferably, in order to dissipate the heat generated by the electronic control unit, preventing the overheating thereof, efficiently and limiting the pressure losses as much as possible, at least one longitudinal fin 40 can be provided (FIGS. 10-12), projecting from the first side of the first cover 6 at said at least one electronic switch 22 and inserted into a corresponding longitudinal recess 41 (FIGS. 3-6), or longitudinal interruption, of at least one bulkhead 9 so that the longitudinal flanks of said at least one longitudinal fin 40 define part of a side wall of two adjacent channels 21 (FIG. 10).

In other words, the longitudinal fin 40 of the cover 6, arranged at an electronic switch 22, is configured to locally replace a portion of bulkhead 9 delimiting two adjacent channels 21 of the flow path 4 of the liquid, said portion of bulkhead 9 corresponding to the space where the longitudinal recess 41, or longitudinal interruption, is provided.

In more detail, as illustrated for example in FIGS. 3-6 and 10-12, each longitudinal fin 40 has a shape substantially complementary to the shape of the corresponding longitudinal recess 41, or longitudinal interruption, of the respective bulkhead 9 such as to keep the side wall of the two adjacent channels 21 substantially unaltered. This means that the longitudinal fin 40 occupies all of the free space of the longitudinal recess 41, or longitudinal interruption, of a corresponding bulkhead 9. In particular, the longitudinal extension of each longitudinal fin 40 is substantially equal to the longitudinal extension of a respective recess or longitudinal interruption 41 provided in a corresponding bulkhead 9.

Therefore, the electronic switch 22 is adequately cooled as the heat exchange surface below said switch increases, but the pressure losses do not increase because the flow of liquid is substantially unaltered, in particular with respect to the flow of the liquid flowing in the channels where no longitudinal recess or longitudinal interruption in the bulkheads is provided. In other words, the insertion of each longitudinal fin 40 in the respective longitudinal recess 41 of the corresponding bulkhead 9 allows the side wall of two adjacent channels 21 to be entirely reconstructed.

In one variant, at least two electronic switches 22 are provided, preferably only two electronic switches, and at least one longitudinal fin 40 is provided at each electronic switch 22 and inserted into a respective longitudinal recess 41, or longitudinal interruption, of a corresponding bulkhead 9.

In a further variant, at least two longitudinal fins 40, preferably only two longitudinal fins, are provided at each electronic switch 22 and inserted into a respective longitudinal recess 41, or longitudinal interruption, of at least one corresponding bulkhead 9, for example of a single bulkhead 9, or of at least two corresponding bulkheads 9, for example of two corresponding bulkheads 9 (FIGS. 10, 11, 13).

In other variants, the following can be provided:
an even number of electronic switches 22 arranged symmetrically with respect to the second median plane Y,
or an odd number of electronic switches, arranged symmetrically with respect to the second median plane Y, also possibly only one electronic switch.

In the example of FIGS. 3-6 and 13, two electronic switches 22 are provided arranged symmetrically with respect to the second plane Y, and the distance between one switch and the inlet section 10 is equal to the distance between the other switch and the outlet section 11.

In all these variants, the longitudinal fin or the longitudinal fins 40 can be smooth along the longitudinal flanks, or corrugated along said longitudinal flanks, for locally inducing a light turbulence and for increasing the heat exchange between electronic switches 22 and liquid.

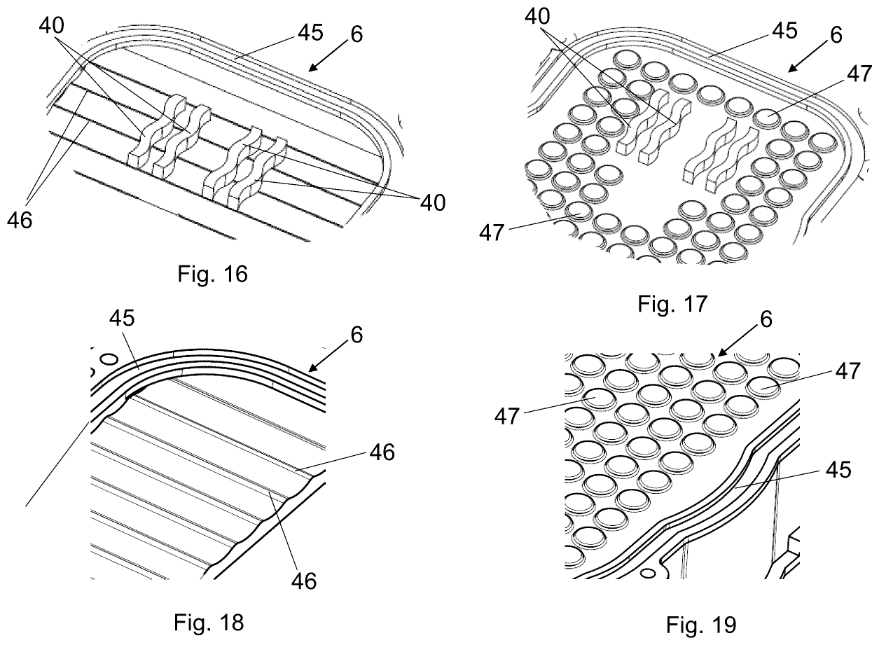

To further increase the dissipation of the heat generated by the electronic control unit it is possible to provide, in addition to the longitudinal fins 40, linear projections 46, preferably but not necessarily parallel to each other, spaced apart by dips (FIG. 16), or projecting pins 47 (FIG. 17) on all or part of the inner surface of the cover 6, i.e. of the aforesaid first side of the cover 6, in contact with the liquid.

An alternative variant does not provide the longitudinal fins 40 but only the linear projections 46 (FIG. 18), preferably but not necessarily parallel to one another, spaced apart by dips, or the projecting pins 47 (FIG. 19) on all or part of the inner surface of the cover 6.

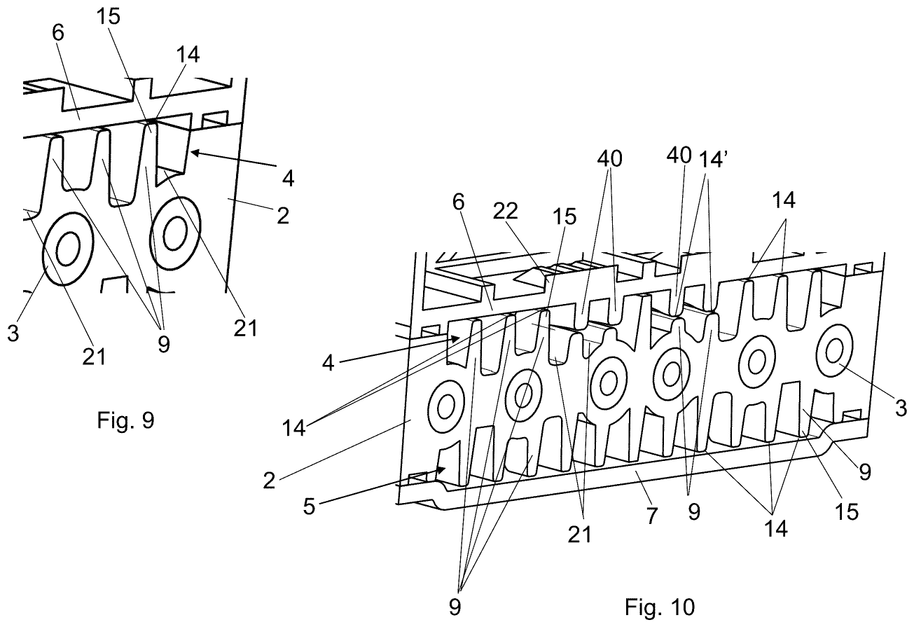

In a further preferred variant of the heater of the invention, illustrated in FIGS. 9 and 10, a gap 14 is provided between the end edge 15 of the bulkheads 9, intermediate to the channels 21, and the first cover 6 and the second cover 7, respectively, whereby the channels 21 of each flow path 4, 5 communicate transversely with each other at this gap. A gap can also be provided between the end edge of the further bulkheads 90, 91 and the respective covers 6, 7.

Preferably, the gap 14 is comprised in a range from 0.01 to 0.4 mm.

Optionally, the end edge 15 of the bulkheads 9, 90, 91 is a rounded edge.

The flow of liquid entering into the heater is diverted into the inlet section 10 in the two flow paths 4, 5 and mainly proceeds into the channels 21, following the shape of the bulkheads. However, because of this gap between the vertices of the bulkheads and the corresponding cover 6, 7, the channels 21 are not hermetically separated and a secondary flow is created transverse to the channels 21, i.e. a secondary bypass flow between the inlet section and the outlet section. Therefore, the channels 21 substantially parallel to one another are not connected in parallel between the inlet section and the outlet section as there is always a transverse flow from one channel to the other.

The advantages of providing this gap are multiple:
avoiding a hyperstatic resting of the covers 6, 7 on the respective faces of the body 2, and thus avoiding tension in assembly between the parts, considering that the parts have planarity errors;
avoiding an extended thermal contact between body 2 and cover onto which the electronic control unit 8 is fastened, so as to reduce to a maximum any transfer of heat from the bulkheads to the electronic control unit; for this purpose, the end edge or tip of the bulkheads can also be rounded to minimize the transfer of heat in any accidental contact points;
promoting the upwards movement of the bubbles due to the effect of the force of relative gravity, preventing any air bubbles in the liquid from stagnating inside the channels, in particular if the flow is slow with the M-shaped flow path.

If one or more longitudinal fins 40 are provided on the first side of the first cover 6 at one or more electronic switches 22, in addition to the gap 14 between the end edge 15 of the bulkheads 9 and the first cover 6 and the second cover 7, respectively, also a second gap 14′ can be provided (FIG. 10) between the longitudinal fins 40 and the corresponding longitudinal recess 41, or longitudinal interruption, of the respective bulkhead 9 of the flow path 4 only. Therefore, the mutually adjacent channels 21 in the flow path 4 are also communicating at the gaps 14′.

The second gap 14′ is also preferably comprised in a range from 0.01 to 0.4 mm.

In a variant, the end edge of the bulkheads 9,90, 91 and/or of the longitudinal fins 40 and/or of the longitudinal recesses 41 is a rounded edge.

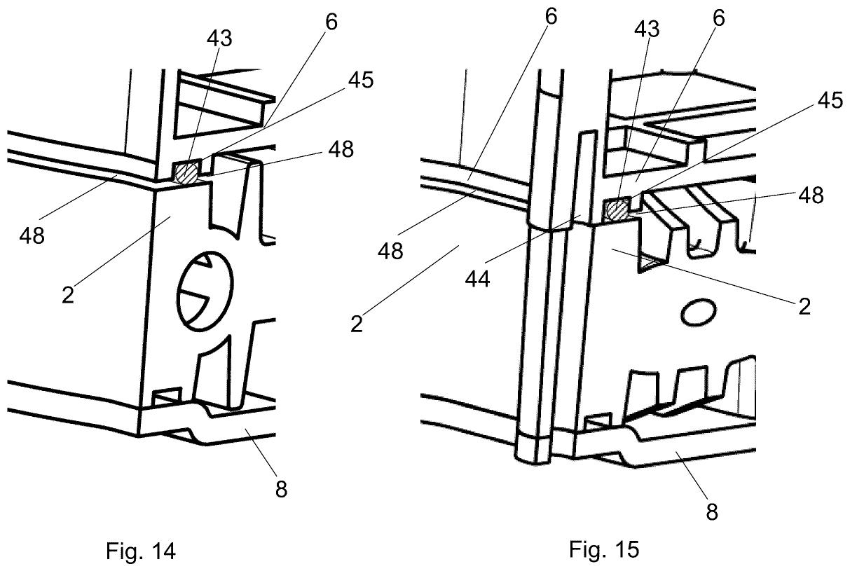

In a further variant illustrated in FIG. 14-15, to further reduce the transfer of heat from the heating body 2 to the cover 6 which also accommodates the electronic control unit, a further gap 48 between body 2 and cover 6 is conveniently provided also in the perimeter area in proximity to the sealing gasket 43, arranged in said perimeter area to prevent the leakage of liquid from the respective flow path towards the outside of the heater.

The sealing gasket 43 is arranged in a perimeter housing 45 made on the respective cover and/or on the respective face of the body 2.

The further gap 48 is provided on both the inner and outer sides of said perimeter housing 45 (FIG. 14), except preferably on the outer side at the outer housings 44 of fastening screws (FIG. 15), which fasten both covers 6, 7, and the body 2 arranged between them, to one another.

In all variants of the heater of the invention, each flow path 4, 5 can be produced according to different embodiments.

A first embodiment of the flow path, illustrated in FIG. 3, provides that the three hairpin bends 30, 31 are bends with an angle at the center greater than 180°, preferably greater than 180° and less than 220°.

In the non-limiting example of FIG. 3, the intermediate hairpin bend 30 has an angle at the center of about 190-200°; whereas the two side hairpin bends 31 have an angle at the center of about 200-220°.

In this embodiment, the channels 21 have the most uniform section as possible and the three hairpin bends 30, 31 are rounded to further reduce the pressure losses. Heat exchange is promoted by the heat exchange surface increase obtained through the bulkheads and not by the shape of the bends 30, 31.

A second embodiment of the flow path, illustrated in FIG. 4, provides that the three hairpin bends 30, 31 are bends with an angle at the center of about 180°; and in which at least one channel 21, preferably the most internal channel, has, at the two side hairpin bends 31, a width A, measured parallel to the second median plane Y, which is greater than the width B of the channel itself, measured perpendicularly to said second median plane Y.

This second embodiment allows the weight and producibility of the body 2 to be optimized. Compared to the first embodiment, the hairpin bends are less rounded; however, to reduce turbulence and pressure losses the width of at least one channel 21 at the side hairpin bends 31 is increased (A>B), so that the fluid slows at the bend and generates less turbulence.

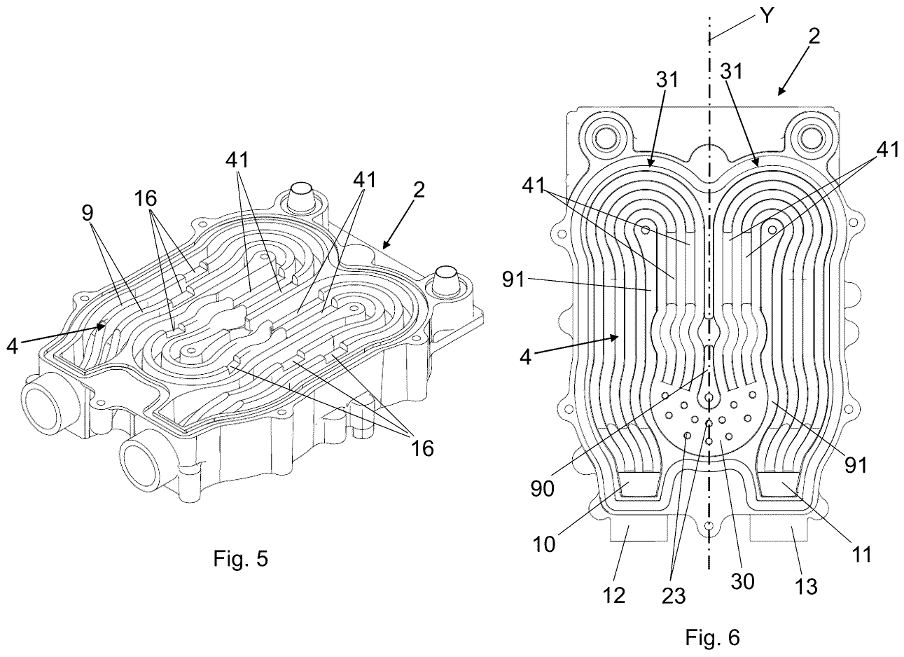

A third embodiment of the flow path, illustrated in FIG. 5, provides that the bulkheads 9, in particular the intermediate bulkheads between one channel 21 and the adjacent one, are provided with at least one respective recess 16 at the end edge 15. Preferably, but not necessarily, the recesses 16 are arranged symmetrically with respect to the median plane Y. In FIG. 5 the number of recesses 16 is equal to six, but their number can be greater or less than 6.

The depth of said recesses 16 is preferably comprised between 0.2 and 3 mm, preferably between 1 and 3 mm.

These recesses 16 further promote the aforesaid transverse flow between the channels 21. By varying their number and position, a predetermined design value of flow transversal to the channels can be defined.

A fourth embodiment of the flow path, illustrated in FIG. 6, provides that at least some bulkheads 9, in particular the intermediate bulkheads between one channel 21 and the adjacent one, are completely interrupted at the intermediate or central hairpin bend 30, and a plurality of protrusions 23 are provided in said intermediate hairpin bend 30.

The protrusions 23 can be in the form of pegs of various possible shapes (circular, oval, rectangular section, etc.), adapted to increase the heat exchange surface locally. In fact, it is possible that at least one electrical resistor 3 has at the central hairpin bends 30 a greater concentration of power. The local increase in heat exchange is obtained by replacing the flow path with substantially M-shaped channels with a flow path with two U-shaped channel stretches, also defined by the bulkheads 91 and connected in sequence from an intermediate curved area from which the pegs 23 project and in which the flow of the channels joins completely.

FIGS. 5 and 6 illustrate the features described for the third and fourth embodiments in combination with the features described above of the first embodiment. Alternatively, it is possible to combine the features described for the third and fourth embodiment with the features described above for the second embodiment.

In all embodiments of the heater of the invention, preferably the at least one electrical resistor 3 is a tubular resistor partially incorporated along the first median plane X of the body 2.

In particular, the heating part of said at least one electrical resistor 3 is completely incorporated into the body 2 along said first median plane X.

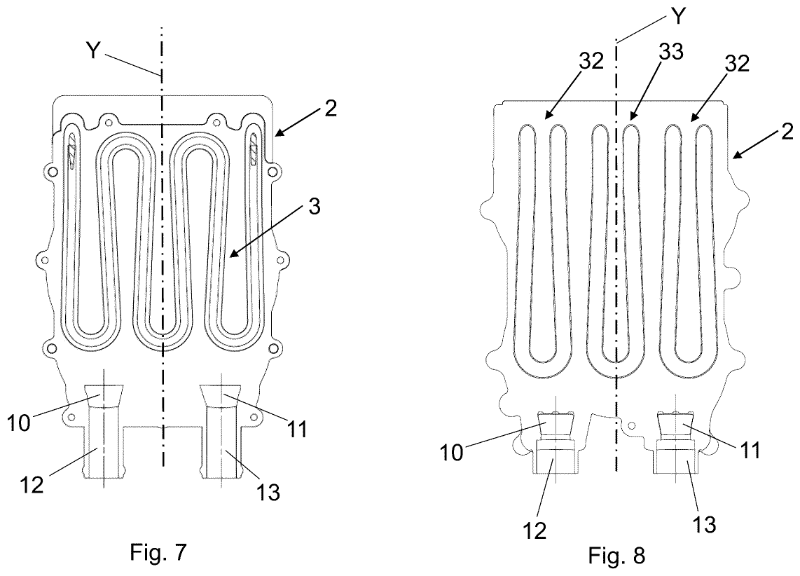

FIG. 7 illustrates a first variant wherein only one tubular serpentine resistor 3 is provided, preferably arranged symmetrically with respect to the second median plane Y.

FIG. 8 illustrates a second variant wherein at least three tubular resistors 33, 32 are provided, which can be electrically connected in series or in parallel; preferably wherein the assembly of said at least three tubular resistors is symmetrically arranged with respect to the second median plane Y.

In all the variants the single resistor 3 or all the resistors 33, 32 are arranged exclusively along the first median plane X, partially incorporated into a single body 2.

1. An electric heater for a vehicle, adapted to heat a liquid crossing said heater, comprising
a body made of die-cast metal material;
at least one electrical resistor at least partially incorporated into the body along a first median plane of said body;
an inlet section and an outlet section for the liquid, both arranged on a same side of the heater;
a first flow path for the liquid, from the inlet section to the outlet section made on a first face of said body arranged at a first side of said first median plane;
a second flow path for the liquid, from said inlet section to said outlet section made on a second face of said body arranged at a second side of said first median plane opposite the first side;
wherein the first flow path and the second flow path which include said inlet section and said outlet section, are arranged symmetrically both with respect to said first median plane and with respect to a second median plane of the body perpendicular to said first median plane.

2. The heater according to claim 1, wherein there are provided
a first cover which closes with a first side thereof the first flow path;
a second cover which closes with a first side thereof the second flow path;
an electronic control unit arranged on a second side of said first cover or second cover, opposite the first side;
wherein said electronic control unit comprises at least one electronic switch arranged in proximity to said second median plane, in a distal position both from said inlet section and from said outlet section.

3. The heater according to claim 1, wherein both the first flow path and the second flow path are provided with an odd number of hairpin bends, and comprise a plurality of channels which branch off from the inlet section and flow into the outlet section; wherein the channels of the first flow path and of the second flow path are delimited by bulkheads projecting respectively from the first face and from the second face of the body.

4. The heater according to claim 3, wherein three hairpin bends are provided and, both for the first flow path and for the second flow path, an intermediate hairpin bend of said three hairpin bends is arranged at the second median plane and proximal to a side of the heater where the inlet section and the outlet section are arranged; while two side hairpin bends of said three hairpin bends are arranged symmetrically with respect to said second median plane and distal from said side of the heater.

5. The heater according to claim 1, wherein there are provided
a first pipe connection, projecting from the body communicating with said inlet section;
and a second pipe connection, projecting from the body, communicating with said outlet section;
wherein said first pipe connection and said second pipe connection are arranged symmetrically with respect to said second median plane.

6. The heater according to claim 5, wherein a ratio between a width (W) both of the first flow path and of the second flow path and an inner diameter of the first pipe connection and of the second pipe connection is in a range from 1 to 2, preferably from 1.2 to 1.6.

7. The heater according to claim 3, wherein a gap is provided between an end edge of the bulkheads and, respectively, a first cover, which closes with a first side thereof the first flow path, and a second cover which closes with a first side thereof the second flow path, whereby the channels communicate transversely with each other at said gap; wherein the end edge of the bulkheads is a rounded edge.

8. The heater according to claim 7, wherein the bulkheads are provided with at least one respective recess at the end edge.

9. The heater according to claim 7, wherein at least some bulkheads are interrupted at an intermediate hairpin bend of the first flow path and of the second flow path said intermediate hairpin bend being arranged at the second median plane and proximal to a side of the heater where the inlet section and the outlet section are arranged; and a plurality of projections are provided into said intermediate hairpin bend.

10. The heater according to claim 4, wherein the hairpin bends are bends with an angle at the center greater than 180°, greater than 180° and less than 220°.

11. A The heater according to claim 4, wherein the three hairpin bends are bends with an angle at the center of about 180°; and wherein at least one channel has, at the two side hairpin bends, a width A, measured parallel to the second median plane, which is greater than the width B of the channel itself, measured perpendicularly to said second median plane.

12. The heater according to claim 1, wherein said at least one electrical resistor is at least a tubular resistor.

13. The heater according to claim 2, wherein a sealing gasket is provided, arranged in a perimeter housing made on the respective first cover and second cover and/or on the respective first face and second face of the body, and wherein a gap is provided at said perimeter housing between the body and the respective cover, on whose second side the electronic control unit is arranged.

14. The heater according to any one of claim 3, wherein there are provided
a first cover which closes with a first side thereof the first flow path;
a second cover which closes with a first side thereof the second flow path;
an electronic control unit arranged on a second side of said first cover or second cover, opposite the first side;
wherein said electronic control unit comprises at least one electronic switch arranged in proximity to said second median plane, in a distal position both from said inlet section and from said outlet section;
and wherein at least one longitudinal fin is provided, projecting from the first side of said first cover or second cover at said at least one electronic switch and inserted into a corresponding longitudinal recess or longitudinal interruption of at least one bulkhead so that longitudinal flanks of said at least one longitudinal fin define part of a side wall of two adjacent channels.

15. The heater according to claim 2, wherein there are further provided, on all or part of the first side of the first cover or second cover, linear projections, parallel to each other, spaced apart by dips, or projecting pins.

16. The heater according to claim 3, wherein at least some bulkheads are interrupted at an intermediate hairpin bend of the first flow path and of the second flow path, said intermediate hairpin bend being arranged at the second median plane and proximal to a side of the heater where the inlet section and the outlet section are arranged; and a plurality of projections are provided into said intermediate hairpin bend.
